(19) United States
(12) Patent Application Publication
(10) Pub. No.: US 2026/0331981 A1
(43) Pub. Date: Oct. 22, 2026

(54) THIN-PLATE MOTOR

(71) Applicant: DELTA ELECTRONICS, INC., Taoyuan City (TW)

(72) Inventors: CHING-HSIEN YEH, Taoyuan City (TW); CHIH-WEI CHAN, Taoyuan City (TW)

(21) Appl. No.: 19/535,828

(22) Filed: Feb. 10, 2026

Related U.S. Application Data
(62) Division of application No. 18/612,371, filed on Mar. 21, 2024.
Application No. 18/612,371 is a continuation-in-part of application No. 17/444,551, filed on Aug. 5, 2021, now abandoned.
Application No. 17/444,551 is a continuation-in-part of application No. 15/859,109, filed on Dec. 29, 2017, now abandoned.
(60) Provisional application No. 62/458,688, filed on Feb. 14, 2017.

(30) Foreign Application Priority Data
Jun. 26, 2017 (CN) 201710494155.9

(51) Int. Cl. H02K 1/30; F04D 25/06; F04D 29/28; H02K 21/22

(52) U.S. Cl. CPC H02K 1/30; F04D 25/06; F04D 29/281; H02K 21/22

(57) ABSTRACT

A thin-plate motor includes a motor shell and a driving device. The driving device is disposed in the motor shell, and the driving device includes a stator structure and a rotor structure. The rotor structure is disposed corresponding to the stator structure. The rotor structure includes a rotor shell and a magnetic structure. The magnetic structure is disposed on an inner wall of the rotor shell. The stator magnetic pole group magnetically drives the magnetic structure as well as the rotor shell to rotate. A wear-resistant piece is arranged at an inner bottom of the base body to abut against the shaft, and the wear-resistant piece is partially removed from an outer peripheral edge to form at least one notch.

### CROSS REFERENCE TO RELATED APPLICATIONS

This application is a Divisional application of U.S. application Ser. No. 18/612,371 filed on Mar. 21, 2024 (now pending), which is a Continuation in Part (CIP) of U.S. application Ser. No. 17/444,551 filed on Aug. 5, 2021 (now abandoned), which is a Continuation in Part (CIP) of U.S. application Ser. No. 15/859,109 filed on Dec. 29, 2017 (now abandoned), which claims priority to U.S. provisional patent application with Ser. No. 62/458,688 filed on Feb. 14, 2017 and also claims priority under 35 U.S.C. § 119(a) on Patent Application No(s). 201710494155.9 filed in People's Republic of China on Jun. 26, 2017, the entire contents of which are hereby incorporated by reference.

### BACKGROUND OF THE INVENTION

### Field of Invention

The present disclosure relates to a thin-plate motor that have an integrally formed rotor shell and shaft.

### Related Art

In the existing electronic device, the heat dissipation efficiency is one of the major factors to determine the performance and lifetime of the electronic device. In general, the electronic device is provided with a fan for dissipating the generated heat. In more detailed, the fan can generate an airflow to increase the heat dissipation efficiency. Since the fan can provide an outstanding heat dissipation efficiency, it is generally applied to various electronic devices.

In order to fit the compact size of various electronic devices, the fan structure or motor is also designed thinner. In the conventional thin fan or thin-plate motor, the rotor shell and shaft of the rotor structure are connected by laser welding due to the limitation of the thickness of the rotor shell. However, the laser welding may cause the unstable of the manufacturing process of the rotor shell, the oil leaking of the rotor shell, the unstable rotation of the rotor structure, and the poor vibration duration.

The above-mentioned connection method and structure are disclosed in U.S. Pat. No. 8,888,450B2 and U.S. Patent Application No. US2008/0187257A1. Since the rotor shell and the shaft are individual parts, the connection thereof will have the above mentioned problems. Besides, the thickness of the rotor shell has limitation, the size of the fan or motor cannot be thinner.

In U.S. Pat. No. 7,021,829B, the rotor shell and the shaft are integrally formed as a single piece by the stamping or casting process. However, the rotor shell made by the stamping process may have assembling error and unstable rotation due to the processing tolerances on, for example, the flatness of the magnetic surface, the accuracy of the inner diameter of the rotor shell, and the draft angle. In particular, the gaps between the components of the ultra-thin fan or ultra-thin-plate motor are very small. Any of the above processing tolerances will cause a very serious interference in the rotation of the rotor structure, and will sufficiently increase the difficulty in the following manufacturing processes and assembling.

Therefore, it is an important subject to improve the stability of the manufacturing process of the rotor structure, increase the accuracy of manufacturing and assembling processes, reducing the assembling processes of the components, and enhance the operation efficiency of the thin fan and thin-plate motor.

### SUMMARY OF THE INVENTION

In view of the foregoing, the present disclosure provides a thin-plate motor, which includes a motor shell and a driving device. The driving device is disposed in the motor shell. The driving device includes a stator structure and a rotor structure. The stator structure includes a stator magnetic pole group and a base body. The base body is connected to the motor shell, and the stator magnetic pole group is disposed on an outer periphery of the base body. The rotor structure is disposed corresponding to the stator structure. The rotor structure includes a rotor shell and a magnetic structure. The rotor shell includes a top plate, an outer sidewall and an oil seal. A center of the rotor shell is formed with a cylindrical shaft. One end of the shaft penetrates into the base body. The oil seal is disposed on the rotor shell and surrounds a periphery of the shaft. The magnetic structure is disposed on an inner wall of the rotor shell. The stator magnetic pole group magnetically drives the magnetic structure as well as the rotor shell to rotate. At least one notch is provided along an inner wall of the base body in an axial direction.

In one embodiment, the inner wall of the base body is further provided with at least one groove along a circumferential direction.

In one embodiment, the at least one notch is positioned at the location of the at least one groove and communicates with the at least one groove.

In one embodiment, the inner wall of the base body is provided with a plurality of notches.

In one embodiment, the plurality of notches are evenly distributed along the inner wall of the base body.

In one embodiment, the plurality of notches are parallel to each other.

In one embodiment, the at least one groove is a closed groove, an open groove, or a threaded groove.

In one embodiment, the inner wall of the base body is provided with a plurality of grooves.

In one embodiment, the plurality of grooves are evenly distributed along the inner wall of the base body.

In one embodiment, the plurality of grooves are parallel to each other.

In one embodiment, the rotor shell is connected to and drives an impeller to rotate.

In one embodiment, a surface of the shaft is configured with a plurality of groove structures, the plurality of groove structures are annular grooves, oblique grooves, V-shaped grooves, or U-shaped grooves.

In one embodiment, an inner surface of the rotor shell facing the stator structure and corresponding to the base body is formed with an oil repellent layer.

The present disclosure further provides a thin-plate motor, including a motor shell and a driving device. The driving device is disposed in the motor shell. The driving device includes a stator structure and a rotor structure. The stator structure includes a stator magnetic pole group and a base body. The base body is connected to the motor shell, and the stator magnetic pole group is disposed on an outer periphery of the base body. The rotor structure is disposed corresponding to the stator structure. The rotor structure includes a rotor shell and a magnetic structure. The rotor shell includes a top plate, an outer sidewall and an oil seal. A center of the rotor shell is formed with a cylindrical shaft. One end of the shaft penetrates into the base body. The oil seal is disposed on the rotor shell and surrounds a periphery of the shaft. The magnetic structure is disposed on an inner wall of the rotor shell. The stator magnetic pole group magnetically drives the magnetic structure as well as the rotor shell to rotate. A wear-resistant piece is arranged at an inner bottom of the base body to abut against the shaft, and the wear-resistant piece is partially removed from an outer peripheral edge to form at least one notch.

In one embodiment, a length of the at least one notch removed inwardly is 20-40% of a length from the outer peripheral edge of the wear-resistant piece to a structural center of the wear-resistant piece.

In one embodiment, the wear-resistant piece has a plurality of notches.

In one embodiment, the plurality of notches are evenly distributed along the outer peripheral edge of the wear-resistant piece.

In one embodiment, the rotor shell is connected to and drives an impeller to rotate.

In one embodiment, a surface of the shaft is configured with a plurality of groove structures, the plurality of groove structures are annular grooves, oblique grooves, V-shaped grooves, or U-shaped grooves.

In one embodiment, an inner surface of the rotor shell facing the stator structure and corresponding to the base body is formed with an oil repellent layer.

As mentioned above, the rotor shell and the shaft of the thin fan and thin-plate motor of the disclosure are a single component manufactured by processing a single material workpiece. Accordingly, the rotor shell and the shaft can be an integrated seamless single component, so that the assembling accuracy, flatness and manufacturing yield of the entire assembly can be improved. This configuration can increase the entire manufacturing stability, and the laser welding process is not needed. Thus, the processes and costs for manufacturing the thin fan or thin-plate motor can be reduced.

An additional turning process is performed to form at least one groove structure, dynamic pattern or thrust pattern on the surface of the rotor structure. Besides, an oil repellent layer is formed on the inner surface of the rotor shell so as to provide the thin fan and thin-plate motor with the ability of preventing oil leakage. This configuration can further improve the operation efficiency and lifetime of the thin fan and thin-plate motor.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a schematic diagram showing a thin fan according to an embodiment of the disclosure;

FIG. 1B is an exploded view of the thin fan of FIG. 1A;

FIG. 1C is a sectional view of the thin fan of FIG. 1A along the line A-A;

FIGS. 2A to 2D are schematic diagram showing different aspects of the protruding structures;

FIGS. 3A to 3D are schematic diagram showing different aspects of the groove structures;

FIG. 4A is a schematic diagram showing a thin-plate motor according to an embodiment of the disclosure;

FIG. 4B is a sectional view of the thin fan of FIG. 4A along the line C-C;

FIG. 5 is a schematic diagram showing a base body with a groove and a notch according to an embodiment of the disclosure;

FIG. 6A is a top view of the base body shown in FIG. 5;

FIGS. 6B-6C are sectional views along the lines D-D and E-E of the base body shown in FIG. 6A;

FIG. 7A is a three-dimensional schematic diagram of a wear-resistant piece according to an embodiment of the disclosure;

FIG. 7B is a top view of the wear-resistant piece according to an embodiment of the disclosure;

FIG. 8A is a three-dimensional schematic diagram of the inner bottom of the base body as shown in FIG. 5, with a wear-resistant plate installed;

FIG. 8B is a sectional view of the assembly of the shaft and bearings in the base body depicted in FIG. 8A;

FIG. 9 is a sectional view of the base body with multiple grooves according to an embodiment of the disclosure;

FIG. 10 is a top view of the base body with multiple notches according to an embodiment of the disclosure;

FIG. 11A is a top view of closed grooves according to an embodiment of the disclosure; and

FIG. 11B is a schematic diagram of closed grooves according to an embodiment of the disclosure.

### DETAILED DESCRIPTION OF THE INVENTION

The present invention will be apparent from the following detailed description, which proceeds with reference to the accompanying drawings, wherein the same references relate to the same elements.

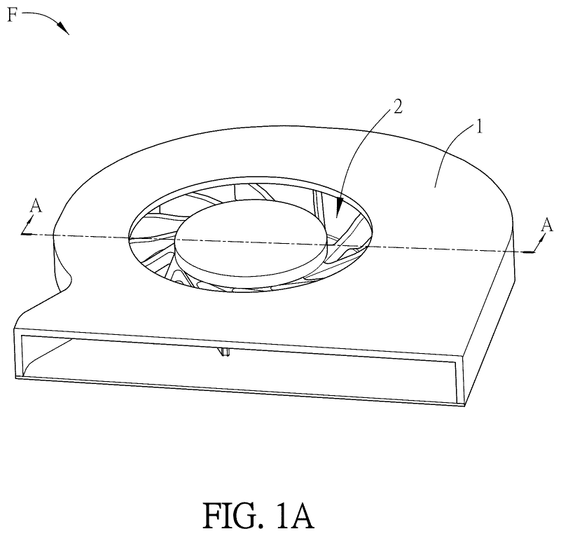

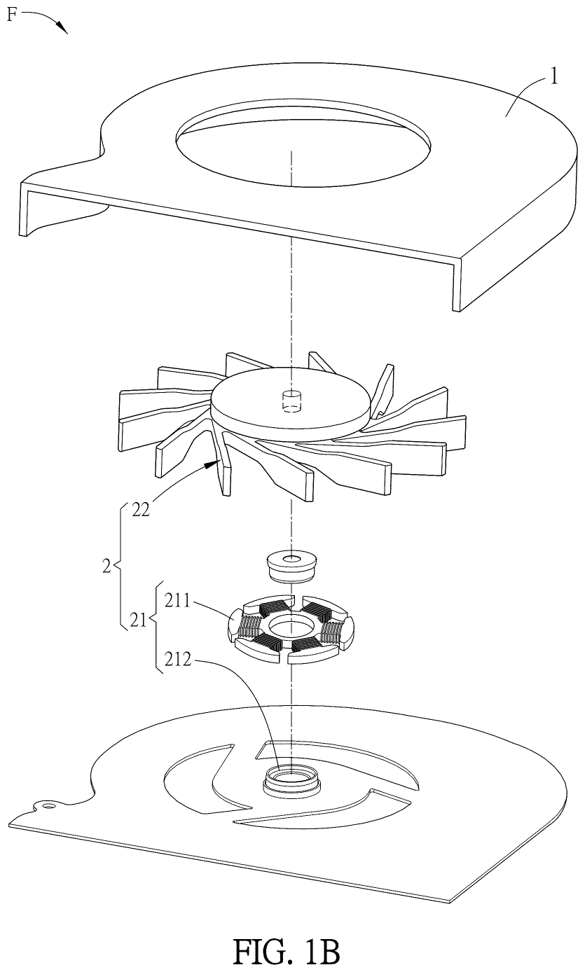

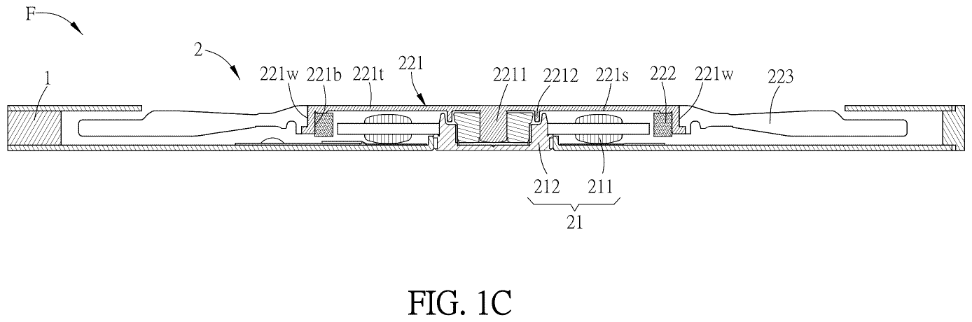

FIG. 1A is a schematic diagram showing a thin fan according to an embodiment of the disclosure, FIG. 1B is an exploded view of the thin fan of FIG. 1A, and FIG. 1C is a sectional view of the thin fan of FIG. 1A along the line A-A.

As shown in FIGS. 1A to 1C, the present disclosure provides a thin fan F, which includes a frame 1 and a driving device 2 disposed in the frame 1. The driving device 2 includes a stator structure 21 and a rotor structure 22. The stator structure 21 includes a stator magnetic pole group 211 and a base body 212. The base body 212 is connected to the frame 1, and the stator magnetic pole group 211 is disposed on an outer periphery of the base body 212. The rotor structure 22 is disposed corresponding to the stator structure 21. The rotor structure 22 includes a rotor shell 221, a magnetic structure 222, and an impeller 223. The rotor shell 221 includes a top plate 221t, an outer sidewall 221w, an oil seal 2212 and a protruding structure 2213. A center of the rotor shell 221 is formed with a cylindrical shaft 2211, and one end of the shaft 2211 penetrates into the base body 212. The base body 212 can be a bearing and/or a bushing. The rotor shell 221 and the shaft 2211 are a single component manufactured by processing a single material workpiece. The magnetic structure 222 is disposed on an inner wall 221b of the rotor shell 221. The stator magnetic pole group 211 magnetically drives the magnetic structure 222 as well as the rotor shell 221 to rotate. The impeller 223 is connected to the rotor shell 221.

In this embodiment, the rotor shell 221 and the shaft 2211 are made of the same metal material or alloy material, and the rotor shell 221 and the shaft 2211 are manufactured by one turning process or one molding process instead of assembling, welding, adhering, or locking. The rotor shell 221 and the shaft 2211 of this embodiment are a seamless and integrated single component. Accordingly, this configuration can satisfy the required rigidity condition of the rotor structure 22, and the metal rotor shell 221 can achieve a thinner design for sufficiently reducing the height of the frame 1. In this embodiment, the maximum height of the frame 1 is not greater than 5 mm. In some embodiments, the maximum height of the frame 1 is 2.5 mm. Accordingly, the thin fan F can be further thinned.

In the thin fan of the disclosure, the rotor shell and the shaft can be manufactured by CNC (Computer Numerical Control) machining or molding to form a seamless and integrated single component. Herein, the rotor structure can be processed by a single machining to achieve the desired accuracy and flatness, so the material for manufacturing the shaft can be reduced so as to decrease the manufacturing cost. Moreover, this process can eliminate the possible breaks and poor flatness of the rotor shell caused by the conventional laser welding process and stamping process. In other words, this disclosure can improve the entire process stability and manufacturing yield, and simplify the assembling process of the thin fan.

As mentioned above, the oil seal 2212 is disposed on the rotor shell 221 and surrounds a periphery of the shaft 2211, and the oil seal 2212 is located corresponding to the base body 212. The base body 212 can be a bearing and/or a bushing, and the oil seal 2212 can be disposed outside the bearing, inside the bushing, or deeply into the space between the bearing and the bushing. Furthermore, due to the single process property of the CNC machining or molding, the rotor shell 221 and the shaft 2211 can be manufactured as a seamless integrated single component, and the configuration of the oil seal 2212 can further enhance the ability of preventing oil leakage of the thin fan F. This can increase the lifetime of the thin fan F, reduce the occupied space of the components, and sufficiently minimize the size of the thin fan F.

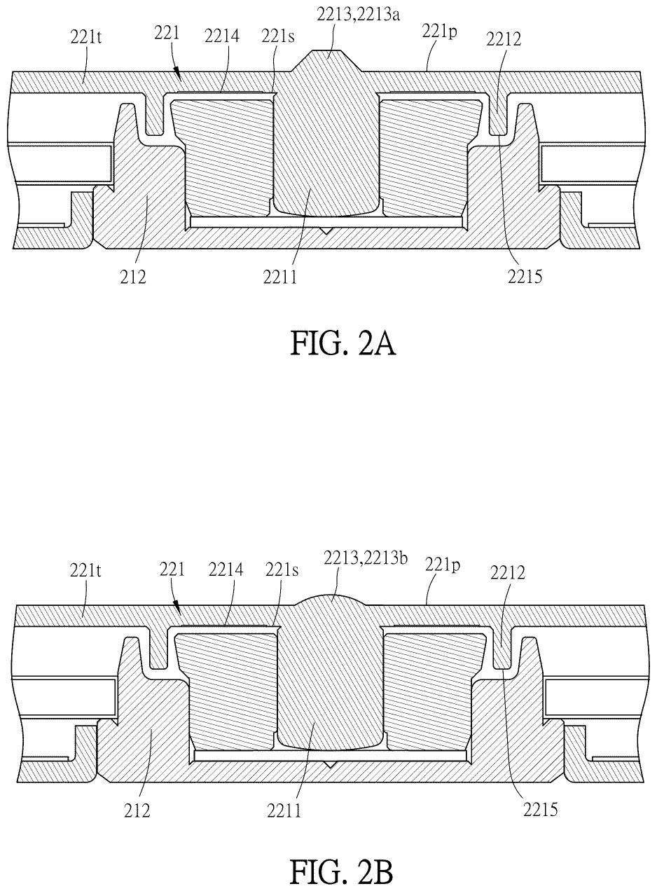

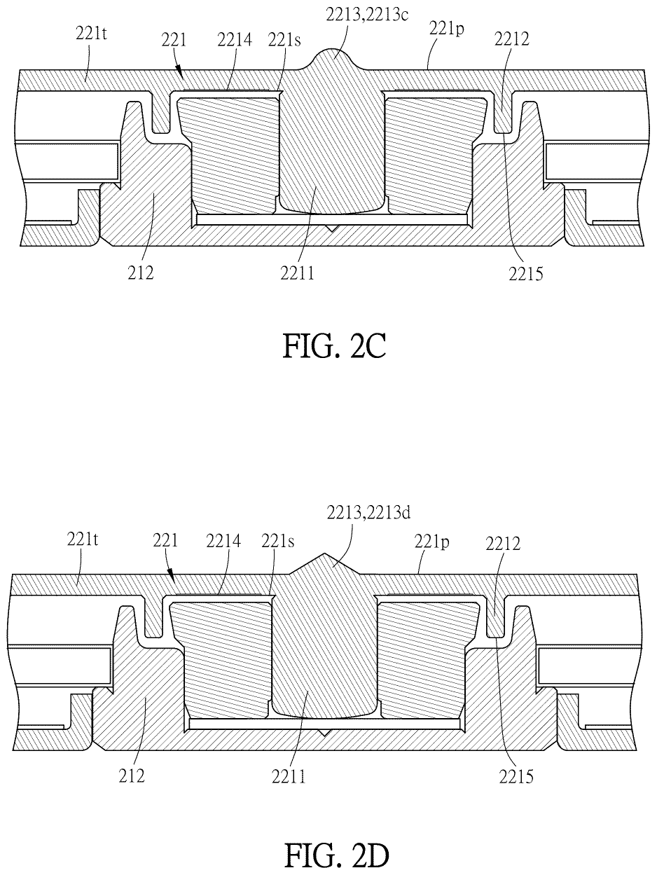

Referring to FIGS. 2A to 2D, in the thin fan F of this disclosure, the protruding structure 2213 is for reducing the collisions between the rotor structure 22 and the external system. The protruding structure 2213 is disposed on an outer surface 221p of the rotor shell 221 away from the shaft 2211. The protruding structure 2213 is located corresponding to the shaft 2211. The top plate 221t, the outer sidewall 221w, the oil seal 2212, protruding structure 2213 and the shaft 2211 are a single component manufactured by processing a single material workpiece. In this embodiment, the protruding structure can be a cylindrical structure 2213a (see FIG. 2A), an arc structure 2213b (see FIG. 2B), a hemispherical structure 2213c (see FIG. 2C), or a cone structure 2213d (see FIG. 2D). Furthermore, due to the single process property of the CNC machining or molding, the protruding structure 2213, the rotor shell 221 and the shaft 2211 can be manufactured as a seamless integrated single component. During the operation of the rotor structure 22, the configuration of the protruding structure 2213 can reduce the collision friction between the rotor structure 22 and the external system, decrease the noise of the thin fan F when applying an external force, and increase the lifetime of the thin fan F. In addition, when the protruding structure 2213 and the shaft 2211 are coaxial, the maximum effect of reducing the friction can be obtained.

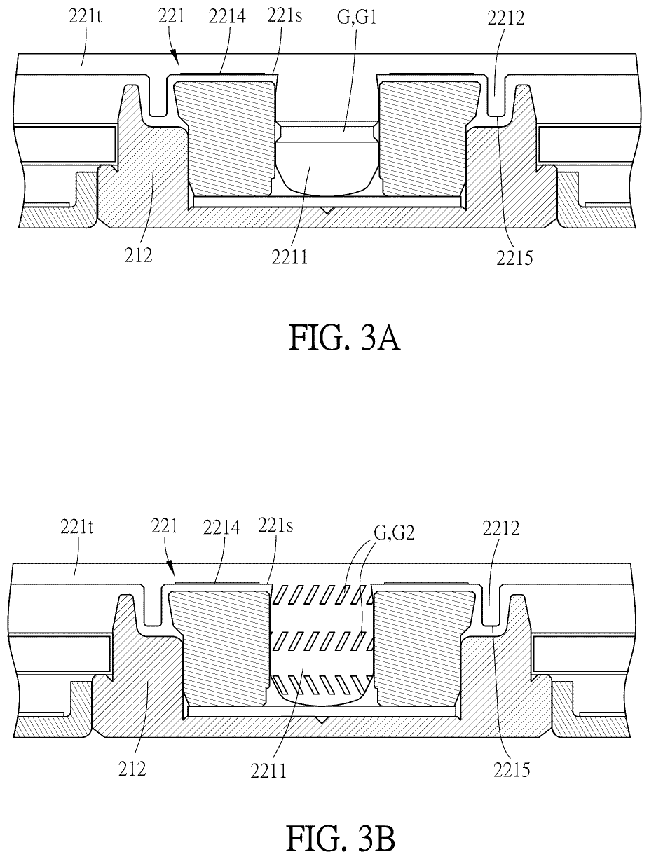

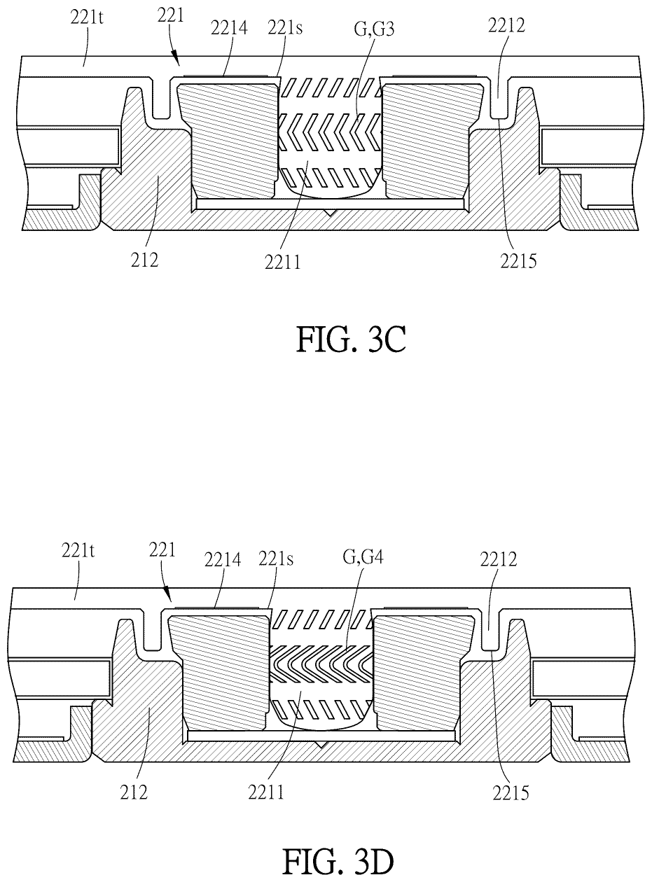

Referring to FIGS. 3A to 3D, in this embodiment, the thin fan F can be processed by CNC machining to form at least one groove structure G on the surface of the shaft 2211. Herein, the groove structure G can be one or more annular grooves G1 (see FIG. 3A), oblique grooves G2 (see FIG. 3B), V-shaped grooves G3 (see FIG. 3C), or U-shaped grooves G4 (see FIG. 3D). The configuration of the groove structures G can increase the axial supporting ability of the shaft 2211 so as to enhance the operation stability of the rotor structure 22 and increase the lifetime of the thin fan F.

In addition, the inner surface 221s of the rotor shell 221 facing the stator structure 21 and corresponding to the base body 212 is configured with at least one dynamic pattern or thrust pattern 2214. Moreover, the inner surface 221s of the rotor shell 221 facing the stator structure 21 and corresponding to the base body 212 is formed with an oil repellent layer 2215. The oil repellent layer 2215 acts as a low surface tension film, this configuration can strongly bounce oil and block oil climbing so as to keep oil within the region of the oil seal 2212. The configuration of the oil repellent layer 2215 in cooperated with the oil seal 2212 can enhance the ability of preventing oil leakage of the thin fan F and increase the lifetime of the thin fan F.

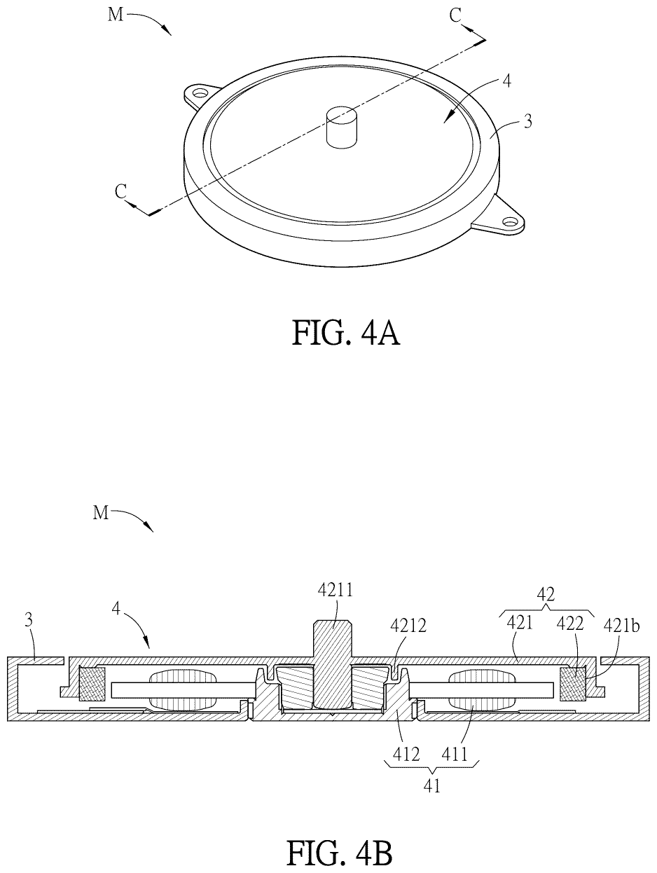

FIG. 4A is a schematic diagram showing a thin-plate motor according to an embodiment of the disclosure, and FIG. 4B is a sectional view of the thin fan of FIG. 4A along the line C-C.

The present disclosure further provides a thin-plate motor M, which includes a motor shell 3 and a driving device 4. The driving device 4 is disposed in the motor shell 3 and includes a stator structure 41 and a rotor structure 42. The stator structure 41 includes a stator magnetic pole group 411 and a base body 412. The base body 412 is connected to the motor shell 3, and the stator magnetic pole group 411 is disposed on an outer periphery of the base body 412. The rotor structure 42 is disposed corresponding to the stator structure 41 and includes a rotor shell 421 and a magnetic structure 422. The center of the rotor shell 421 is formed with a cylindrical shaft 4211. One end of the shaft 4211 penetrates into the base body 412. The base body 412 can be a bearing and/or a bushing. The rotor shell 421 and the shaft 4211 are a single component manufactured by processing a single material workpiece. The magnetic structure 422 is disposed on an inner wall 421b of the rotor shell 421. The stator magnetic pole group 411 magnetically drives the magnetic structure 422 as well as the rotor shell 421 to rotate. The rotor shell 421 includes an oil seal 4212.

In this embodiment, the rotor shell 421 and the shaft 4211 are made of the same metal material or alloy material, and the rotor shell 421 and the shaft 4211 are manufactured by one turning process or one molding process instead of assembling, welding, adhering, or locking. The rotor shell 421 and the shaft 4211 of this embodiment are a seamless and integrated single component. Accordingly, this configuration can satisfy the required rigidity condition of the rotor structure 42, and the metal rotor shell 421 can achieve a thinner design for sufficiently reducing the height of the motor shell 3. In this embodiment, the maximum height of the motor shell 3 is not greater than 5 mm. In some embodiments, the maximum height of the motor shell 3 is 2.5 mm. Accordingly, the thin-plate motor M can be further thinned.

In the thin-plate motor of the disclosure, the rotor shell and the shaft can be manufactured by CNC (Computer Numerical Control) machining or molding to form a seamless and integrated single component. Herein, the rotor structure can be processed by a single machining to achieve the desired accuracy and flatness, so the material for manufacturing the shaft can be reduced so as to decrease the manufacturing cost. Moreover, this process can eliminate the possible breaks and poor flatness of the rotor shell caused by the conventional laser welding process and stamping process. In other words, this disclosure can improve the entire process stability and manufacturing yield, and simplify the assembling process of the thin-plate motor.

The other features of the thin-plate motor M of this embodiment (e.g. the oil seal, oil repellent layer, groove structures, dynamic patterns, thrust patterns, and the likes) can be referred to those of the thin fan F, so the detailed descriptions thereof will be omitted.

In summary, the rotor shell and the shaft of the thin fan and thin-plate motor of the disclosure are a single component manufactured by processing a single material workpiece with turning or molding process. Accordingly, the rotor structure can achieve the desired accuracy, flatness and manufacturing yield by a single process. This process can eliminate the possible breaks and poor flatness of the rotor shell caused by the conventional laser welding process and stamping process. In other words, this disclosure can improve the entire process stability, reduce the assembling processes, and decrease the manufacturing and detection costs.

In addition, an additional turning process is performed to form at least one groove structure, dynamic pattern or thrust pattern on the surface of the rotor structure. Besides, an oil repellent layer is formed on the inner surface of the rotor shell so as to provide the thin fan and thin-plate motor with the ability of preventing oil leakage. This configuration can further improve the operation efficiency and lifetime of the thin fan and thin-plate motor.

Due to the limited space for accommodating lubricating oil internally, a design capable of holding more lubricating oil is required for the thin-plate motor to facilitate lubrication during operation, thereby avoiding insufficient lubrication and damage caused by oil leakage. Additionally, during the operation of the thin-plate motor, it is necessary to exhaust the gases inside the thin-plate motor to prevent insufficient exhaust capacity from causing gas to push lubricating oil out of the gap between the shaft and bearings, leading to leakage issues and thereby reducing the lifespan and reliability of thin fans.

Therefore, the present invention particularly makes improvements in the design of the base body and wear-resistant piece structures to accommodate more lubricating oil and to exhaust gases during the operation of thin-plate motors.

### Special Configuration of the Base Body

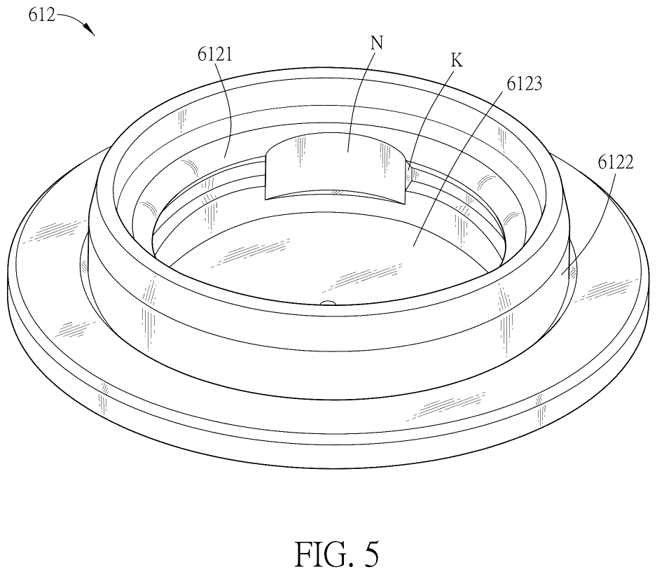

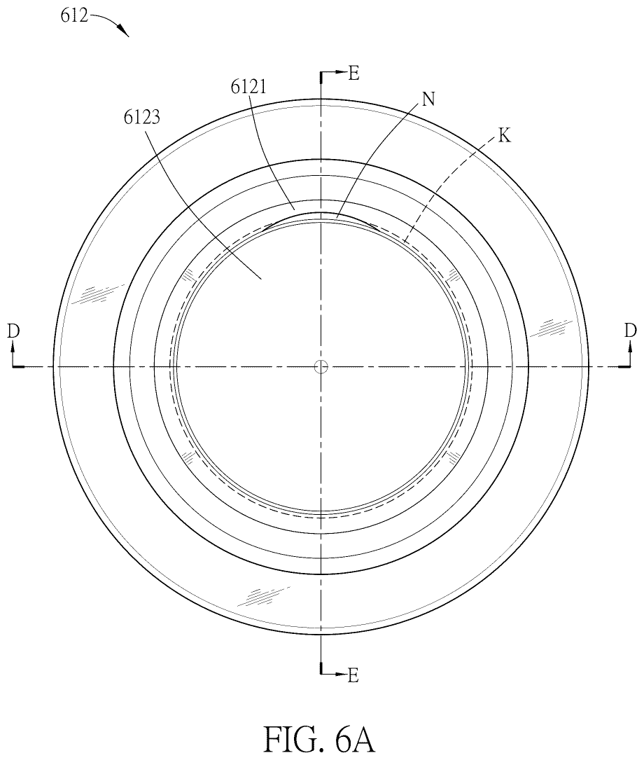

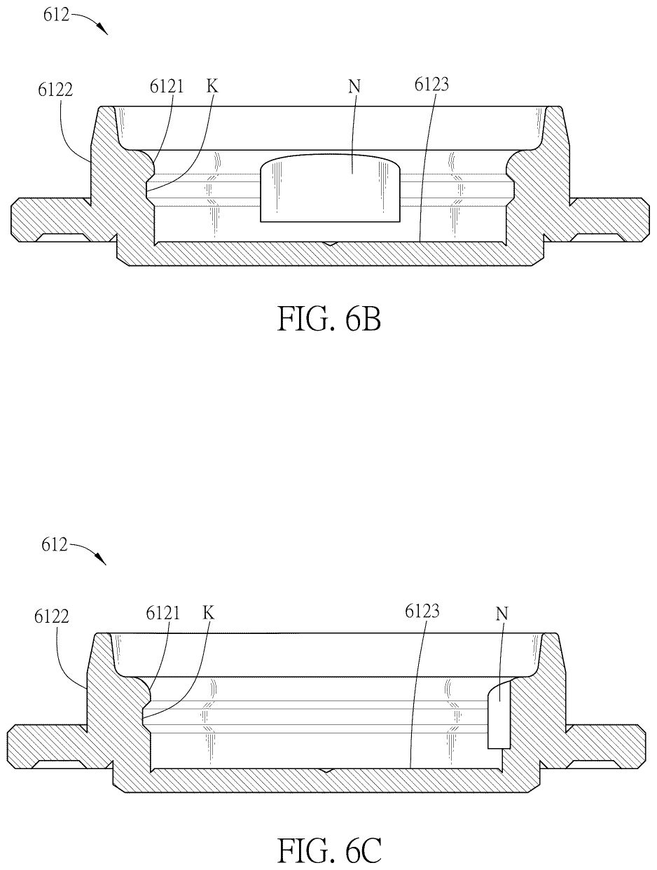

Referring to FIGS. 5 and 6, in terms of the base body 612, while considering the base body strength, additional space for accommodating lubricating oil, and the exhaust of gases present inside the thin-plate motor, at least one groove K is added along the inner wall 6121 of the base body 612 in the circumferential direction. The groove K is primarily designed to provide additional space for accommodating lubricating oil further, in addition to the original design for holding lubricating oil; and before the gases present inside the thin-plate motor are exhausted, the groove K can also provide space for accommodating gases.

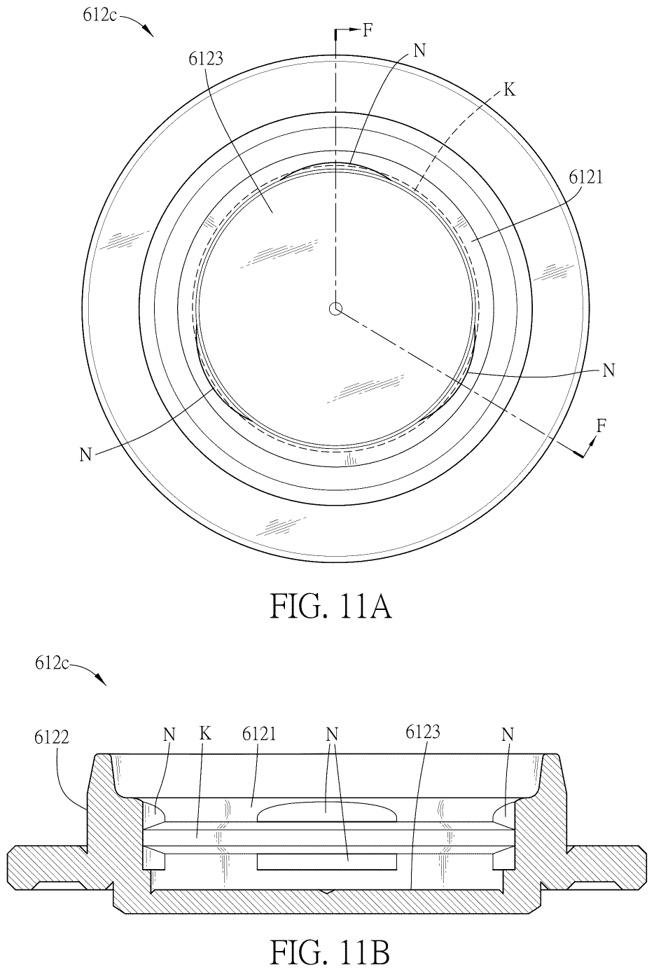

The shape of groove K can be semi-circular, arc-shaped, elliptical, triangular, rectangular, trapezoidal, inverted trapezoidal, polygonal, etc. The form of groove K can be closed (as shown in FIGS. 11A and 11B), open, or threaded.

The groove K is formed by removing a portion of the base body 612 from the inner wall 6121 to the outer wall 6122, while still retaining a certain thickness to ensure sufficient strength of the base body 612. The portion removed for groove K is approximately 10-30% of the thickness dimension.

When the base body 612 has a plurality of grooves K, the grooves K can be evenly distributed along the inner wall 6121 of the base body 612, with equal distances between any two grooves K (as shown in FIG. 9); alternatively, the grooves K can be unevenly distributed along the inner wall 6121 of the base body 612, with varying distances between any two grooves K. Additionally, the grooves K can be parallel or non-parallel to each other.

In the embodiment, at least one notch N is further provided along the axial direction on the inner wall 6121 of the base body 612, with the at least one notch N positioned at the location of the groove K. This facilitates rapid exhaust of gas present inside the thin-plate motor during assembly. The at least one notch N is formed by removing a portion of the base body 612 from the inner wall 6121 to the outer wall 6122, and can communicate with the groove K, while retaining a certain thickness to ensure sufficient strength of the base body 612. The portion removed for the notch N is approximately 10-30% of the thickness dimension.

During assembly, lubricating oil is injected into the base body after the bearings are mounted. During the lubricating oil injection process, the lubricating oil displaces the gas present inside the base body. Through the design of the notch N, a mechanism is provided for exhausting gas from inside the base body, achieving the primary function of rapid gas exhaust.

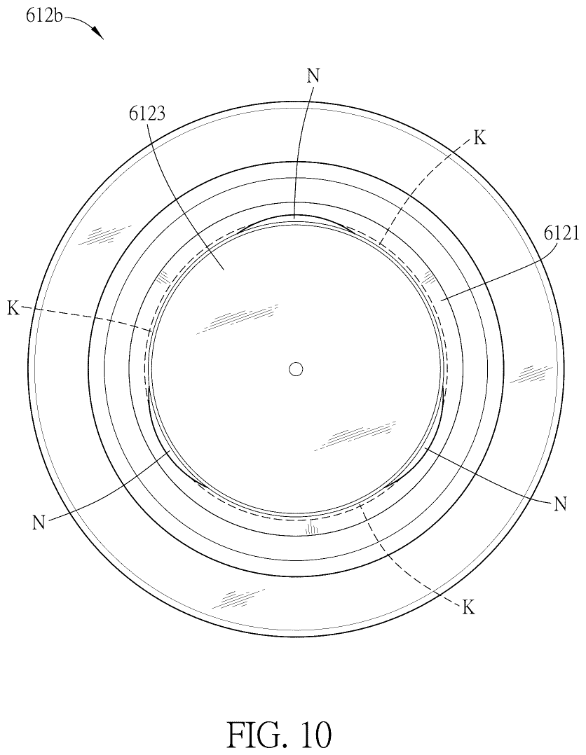

When the base body 612 has a plurality of notches N, the notches N can be evenly distributed along the inner wall 6121 of the base body 612, with equal distances between any two notches N (as shown in FIG. 10); alternatively, these notches N can be unevenly distributed along the inner wall 6121 of the base body 612, with varying distances between any two notches N.

The present invention does not impose significant restrictions on the number, shape, form, dimensions (width, depth, or radius of arc R), distribution, etc., of the grooves K. Similarly, the present invention does not impose significant restrictions on the number, shape, dimensions, distribution, etc., of the notches N. These factors are determined based on practical application requirements.

### Special Configuration of the Wear-Resistant Pieces

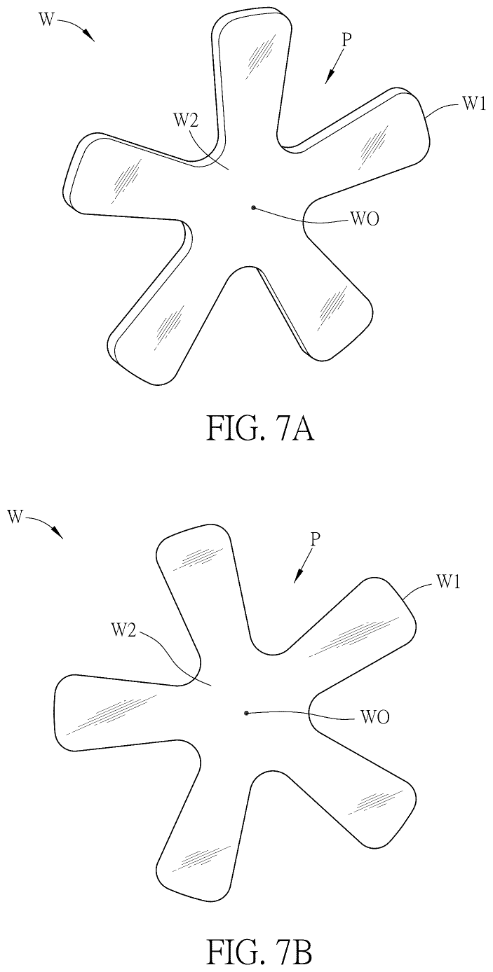

Referring to FIG. 7, in terms of the wear-resistant piece W, a wear-resistant piece W is positioned at the inner bottom 6123 of the base body 612 to abut against the shaft. Considering factors such as rapid gas exhaust during assembly, strength, and additional lubricating oil accommodation space, the wear-resistant piece W is improved from a conventional circular body to a design with at least one notch P, removing portions of the body inwardly from the outer peripheral edge W1 of the wear-resistant piece W to form the at least one notch P.

Furthermore, The at least one notch P can provide additional space for lubricating oil under the original design for oil retention, while ensuring that the wear-resistant piece W maintains sufficient strength. Additionally, if there are residual gases remaining inside the thin-plate motor that have not been exhausted, the notch P also provide space for gas accommodation.

During assembly, lubricating oil is injected into the base body after the bearings are mounted. During the lubricating oil injection process, the lubricating oil displaces the gas present inside the base body. Through the design of the notch P, a mechanism is provided for exhausting gas from inside the base body, achieving the primary function of rapid gas exhaust.

The shape of the notch P on the wear-resistant piece W is not restricted; the notch P is formed by removing portion of the body inwardly from the outer peripheral edge W1 of the wear-resistant piece W, while still retaining the central portion W2 to abut against the shaft. To ensure sufficient strength of the wear-resistant piece W, the length of material removed inwardly for notch P is approximately 20-40% of the length from the outer peripheral edge W1 to the structural center WO of the wear-resistant piece W.

When the wear-resistant piece W has multiple notches P, these notches P can be evenly distributed along the outer peripheral edge of the wear-resistant piece, with equal distances between any two notches P; alternatively, these notches P can be unevenly distributed along the outer peripheral edge W1 of the wear-resistant piece W, with varying distances between any two notches P. Additionally, these notches P can have identical or different shapes, and the dimensions of material removed inwardly from the outer peripheral edge can also be identical or different. The present invention does not impose significant restrictions on the number, shape, dimensions, distribution, etc., of the notches P, and they are determined based on practical application requirements.

In this embodiment, taking the wear-resistant piece originally circular as an example, the wear-resistant piece W is equipped with 5 notches P evenly distributed along its circumference, with each notch P having the same shape and size, resembling petals of a flower. As mentioned above, these 5 notches P provide additional space for accommodating lubricating oil.

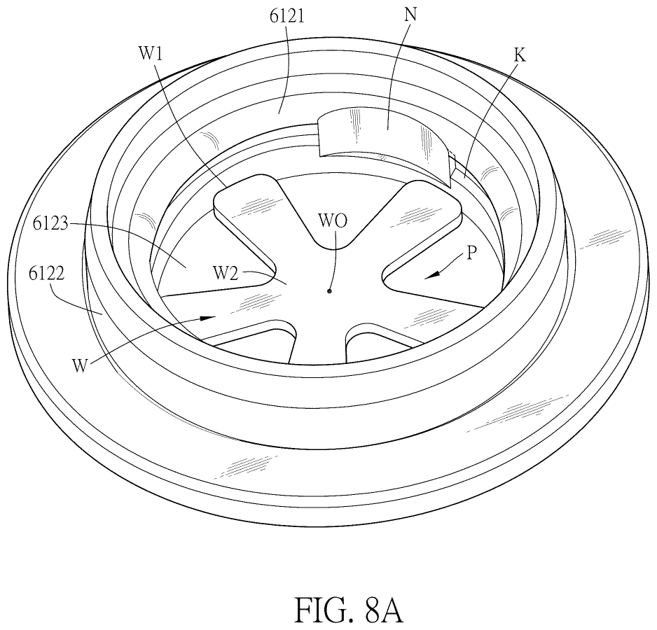

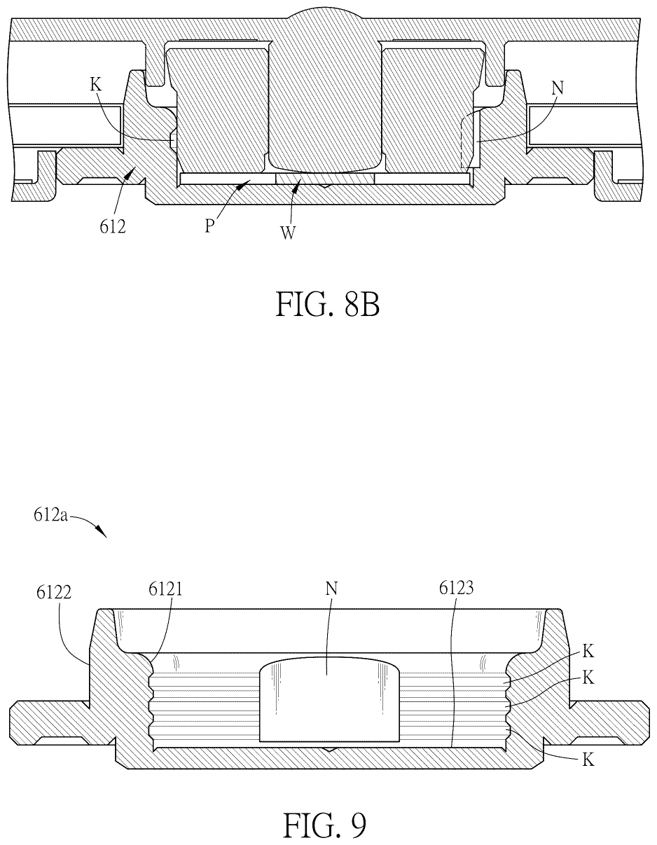

As shown in FIGS. 8A and 8B, in the embodiment, the combination of a wear-resistant piece W with at least one notch P and at least one notch N on the base body 612 allows for the rapid expulsion of gases present inside the thin-plate motor. The unique configuration of the wear-resistant plate W facilitates the rapid discharge of gases to the at least one notch N when the shaft and bearings are assembled and lubricating oil is injected.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A thin-plate motor, comprising:
a motor shell; and
a driving device disposed in the motor shell, the driving device comprising:
a stator structure comprising a stator magnetic pole group and a base body, wherein the base body is connected to the motor shell, and the stator magnetic pole group is disposed on an outer periphery of the base body; and
a rotor structure disposed corresponding to the stator structure, wherein the rotor structure comprises:
a rotor shell comprising a top plate, an outer sidewall and an oil seal, wherein a center of the rotor shell is formed with a cylindrical shaft, one end of the shaft penetrates into the base body, the oil seal is disposed on the rotor shell and surrounds a periphery of the shaft; and
a magnetic structure disposed on an inner wall of the rotor shell, wherein the stator magnetic pole group magnetically drives the magnetic structure as well as the rotor shell to rotate,
wherein a wear-resistant piece is arranged at an inner bottom of the base body to abut against the shaft, and the wear-resistant piece is partially removed from an outer peripheral edge to form at least one notch.

2. The thin-plate motor of claim 1, wherein a length of the at least one notch removed inwardly is 20-40% of a length from the outer peripheral edge of the wear-resistant piece to a structural center of the wear-resistant piece.

3. The thin-plate motor of claim 1, wherein the wear-resistant piece has a plurality of notches.

4. The thin-plate motor of claim 3, wherein the plurality of notches are evenly distributed along the outer peripheral edge of the wear-resistant piece.

5. The thin-plate motor of claim 1, wherein the rotor shell is connected to and drives an impeller to rotate.

6. The thin-plate motor of claim 1, wherein a surface of the shaft is configured with a plurality of groove structures, the plurality of groove structures are annular grooves, oblique grooves, V-shaped grooves, or U-shaped grooves.

7. The thin-plate motor of claim 1, wherein an inner surface of the rotor shell facing the stator structure and corresponding to the base body is formed with an oil repellent layer.

8. The thin-plate motor of claim 1, wherein an inner wall of the base body is provided with at least one groove along a circumferential direction.

9. The thin-plate motor of claim 8, wherein the at least one groove is a closed groove, an open groove, or a threaded groove.

10. The thin-plate motor of claim 8, wherein the inner wall of the base body is provided with a plurality of grooves.

11. The thin-plate motor of claim 10, wherein the plurality of grooves are evenly distributed along the inner wall of the base body.

12. The thin-plate motor of claim 10, wherein the plurality of grooves are parallel to each other.
